(19) United States
(12) Patent Application Publication
(10) Pub. No.: US 2024/0141255 A1
(43) Pub. Date: May 2, 2024

(54) FABRIC SPRAY COMPOSITION

(71) Applicant: Conopco, Inc., d/b/a UNILEVER, Englewood Cliffs, NJ (US)

(72) Inventors: Karl BURGESS, Prenton, Wirral (GB); Alastai Richard SANDERSON, Ellesmere Port (GB); Iain Murdoch STEVENSON, Bracknell (GB)

(73) Assignee: Conopco, Inc., d/b/a UNILEVER, Englewood Cliffs, NJ (US)

(21) Appl. No.: 18/286,738

(22) PCT Filed: Apr. 14, 2022
(86) PCT No.: PCT/EP2022/059996

§ 371 Date: Oct. 12, 2023

(30) Foreign Application Priority Data
Apr. 15, 2021 (EP) 21168514.4

(51) Int. Cl. C11D 1/72; C11D 3/00; C11D 3/37; C11D 3/50; C11D 17/00

(52) U.S. Cl. CPC C11D 1/72; C11D 1/721; C11D 3/0015; C11D 3/3742; C11D 3/50; C11D 17/0043; C11D 2111/12

(57) ABSTRACT

A fabric spray composition comprising an ingredient comprising at least one ethoxylate unit and at least one carbon derived from carbon capture.

### FIELD OF THE INVENTION

The present invention relates to fabric sprays comprising carbon from carbon capture.

### BACKGROUND OF THE INVENTION

Fabric sprays may comprise ingredients comprising ethoxylate groups, such as alcohol ethoxylates and polyethylene glycol ingredients.

Fragrance performance is an essential feature for fabric sprays. Many consumers judge the efficacy of the product based on perfume performance. Perfume performance may be judged on the product in the bottle, when first sprayed onto the fabric, or during the use of the fabric. Fragrance performance may be judged by quantity of fragrance, longevity or quality.

Stability is also an important feature of fabric sprays. Instability is indicated by separation, increased or decreased viscosity, a change in the fragrance or a change in the aesthetics, such as a colour change.

Finally, the aesthetics of the fabric spray are important, since the compositions tend to be clear. Aesthetics and stability are very closely linked; poor aesthetics can indicate poor stability. Equally aesthetics can be linked to the fragrance composition within a product.

There is a need to further improve fabric spray fragrance performance, aesthetics and/or stability.

In addition to the need for improved fabric sprays, there is a growing need to address climate change, in particular greenhouse gases. There is a need to slow the rate at which carbon containing gases enter the atmosphere. In light of this, some consumers prefer so called ‘eco-friendly’ products which have a reduced impact on the environment. However often consumers associate ‘eco-friendly’ products reduced efficacy. Equally consumers can find it difficult to understand in tangible terms, the positive impact a product may have on the environment.

In view of the above, there remains a need for fabric spray compositions with a good environmental profile without compromising consumer satisfaction in terms of fragrance, stability and/or aesthetic performance.

### SUMMARY OF THE INVENTION

We have found that the fabric spray compositions described herein, comprising an ingredient comprising at least one ethoxylate unit and at least one carbon derived from carbon capture, provide an improved environmental profile while maintaining or improving consumer satisfaction. In particular, a difference in fragrance profile is provided when an ingredient comprising at least one ethoxylate unit and at least one carbon derived from carbon capture are included in a fabric spray composition. The difference in fragrance profile allows the consumer to identify a more environmentally friendly product and allows the producer the simplicity of continuing to use the same fragrance, but achieving a different fragrance profile. Viscosity may also be improved leading to a lower product viscosity. Without wishing to be bound by theory it is believed that improvements in the fabric spray are a consequence of the ingredients comprising carbon atoms from carbon capture.

In one aspect of the present invention is provided a fabric spray composition comprising:
a) ingredient comprising at least one ethoxylate unit and at least one carbon derived from carbon capture.

The invention further relates to a method of preparing a fabric spray composition, wherein the method comprises the steps of:
i. Obtaining an ingredient comprising at least one ethoxylate unit and at least one carbon derived from carbon capture;
ii. Incorporating said ingredient into a fabric spray composition.

The invention additionally relates to a use of a fabric spray composition as described herein to reduce carbon emissions into the atmosphere.

### DETAILED DESCRIPTION

These and other aspects, features and advantages will become apparent to those of ordinary skill in the art from a reading of the following detailed description and the appended claims. For the avoidance of doubt, any feature of one aspect of the present invention may be utilised in any other aspect of the invention. The word “comprising” is intended to mean “including” but not necessarily “consisting of” or “composed of.” In other words, the listed steps or options need not be exhaustive. It is noted that the examples given in the description below are intended to clarify the invention and are not intended to limit the invention to those examples per se. Similarly, all percentages are weight/weight percentages unless otherwise indicated. Except in the operating and comparative examples, or where otherwise explicitly indicated, all numbers in this description indicating amounts of material or conditions of reaction, physical properties of materials and/or use are to be understood as modified by the word “about”. Numerical ranges expressed in the format “from x to y” are understood to include x and y. When for a specific feature multiple preferred ranges are described in the format “from x to y”, it is understood that all ranges combining the different endpoints are also contemplated.

The term ‘virgin fossil fuels’ refers to fossil fuel sources (coal, crude oil, natural gas) which have not been used for any other purpose, i.e. has not been burnt for energy, or is not the waste gas from an industrial process.

The term ‘biomass’ refers to organic mass derived from plant materials and/or microorganisms (such as algae/microalgae/fungi/bacteria). Biomass includes, plant materials, agricultural residues/waste, forestry residues/waste, municipal waste provided this excludes fossil, yard waste, manufacturing waste, landfill waste, sewage sludge, paper and pulp etc. and the like.

The compositions described herein comprise ingredients comprising at least one ethoxylate unit and at least one carbon derived from carbon capture. To obtain these ingredients from carbon capture, carbon must be captured, separated (where required) and utilised or transformed into an ingredient for use in a fabric spray. The capture, separation and transformation may happen in one continuous process or may be separate steps which may be carried out at different locations.

Carbon Capture and Separation

Carbon capture refers to the capture or sequestration of C1 carbon molecules (e.g. carbon monoxide, carbon dioxide, methane or methanol). By capturing the carbon molecules, they are removed from or prevented from entering the environment. Carbon sourced from carbon capture contrasts with carbon from virgin fossil fuels (crude oil, natural gas, etc.), in that captured carbon has already been used at least once; for example captured carbon may have been burned to produce energy and is captured to enable a second use of the carbon, whereas carbon from virgin fossil fuels have been extracted for that singular purpose. Captured carbon may equally be obtained from non-fossil fuel carbon emitters, such as biomass energy plants, brewery gases from fermentation (e.g. of wheat), burning of biomass fuels (e.g. vegetable oil, biogas or bio-ethanol). By capturing and utilising carbon, carbon can be used again, leading to less carbon in the atmosphere and reduced use of virgin fossil fuels. In other words by capturing carbon either already in the atmosphere or before it enters the atmosphere, the nett reliance on virgin fossil fuels to produce homecare products is reduced The carbon captured may be in any physical state, preferably as a gas.

C1 carbon capture can be used to help reduce/prevent net release of CO₂ in the environment and thereby forms a valuable tool to address climate change. When the C1 carbons captured are derived from combusted fossil sources then the immediate CO₂ released can be reduced. When C1 carbons are derived directly from the atmosphere or from bio-sources there may even be a net immediate reduction in atmospheric CO₂ Carbon capture may be point source carbon capture or direct carbon capture. Direct carbon capture refers to capturing carbon from the air, where it is significantly diluted with other atmospheric gases. Point source carbon capture refers to the capture of carbon at the point of release into the atmosphere. Point source carbon capture may be implemented for example at steal works, fossil fuel or biomass energy plants, ammonia manufacturing facilities, cement factories, etc. These are examples of stationary point source carbon capture. Alternatively, the point source carbon capture may be mobile, for example attached to a vehicle and capturing the carbon in the exhaust gases. Point source carbon capture may be preferable due to the efficiency of capturing the carbon in a high concentration. Preferably, the carbon is captured from a point source. More preferably the carbon is captured from a fossil fuel based point source, i.e. carbon captured from an industry utilising fossil fuels.

There are various methods of capturing carbon from industrial processes, examples include:
Capturing carbon from flue gasses following combustion. This may be referred to as post combustion carbon capture. For example this may be implemented to capture carbon from the flue gasses at a fossil fuel power plant.
Capturing carbon pre-combustion. In these processes, fossil fuels are partially oxidized. Syngas comprising carbon monoxide, hydrogen and some carbon dioxide is produced. The carbon monoxide is reacted with water (steam) to produce carbon dioxide and hydrogen. The carbon dioxide can be separated, and the hydrogen used as fuel.
Oxy-fuel combustion, in which fuel is burned in oxygen rather than air. The flue gas consists mainly of carbon dioxide and water vapour. The water is separated and the carbon dioxide collected.

Once a source of carbon has been captured, the carbon molecules need to be isolated from the other chemicals with which they may be mixed. For example, oxygen, water vapour, nitrogen etc. In some point source processes this step may not be required since a pure source of carbon is captured. Separation may involve biological separation, chemical separation, absorption, adsorption, gas separation membranes, diffusion, rectification or condensation or any combination thereof.

A common method of separation is absorption or carbon scrubbing with amines. Carbon dioxide is absorbed onto a metal-organic framework or through liquid amines, leaving a low carbon gas which can be released into the atmosphere. The carbon dioxide can be removed from the metal-organic framework or liquid amines, for example by using heat or pressure.

C1 carbon molecules sourced from carbon capture and suitably separated from other gases are available from many industrial sources. Suitable suppliers include Ineos. Capturing carbon directly from the air may for example involve passing air over a solvent which physically or chemically binds the C1 molecules. Solvents include strongly alkaline hydroxides such as potassium or sodium hydroxide. For example air may be passed over a solution of potassium hydroxide to form a solution of potassium carbonate. The carbonate solution is purified and separated to provide a pure CO₂ gas. This method may also be employed in point source capture. An example of a direct air capture process is that employed by carbon engineering.

Carbon Utilisation or Transformation

Once the C1 carbon molecules have been capture and separated, they can then be transformed into useful ingredients for use in a fabric spray.

Various methods may be used to transform the captured C1 molecules to useful components. The methods may involve chemical process or biological processes, such as microbial fermentation, preferably gas-fermentation.

Preferably the C1 molecules are transformed into:
i. Short chain (preferably C1-C5) intermediates such as methanol, ethanol, ethylene, ethylene oxide; or
ii. Hydrocarbon intermediates (preferably C6-C20) such as hydrocarbon chains: alkanes, alkenes, etc.

These can be converted further to make the components of surfactants, using well known chemistries e.g. chain growth reactions etc to: longer chain alkenes/olefins, alkanes, longer chain alcohols, aromatics and ethylene, ethylene oxide which is an excellent starter chemical for various ingredients. Preferably the C1 molecules are transformed into short chain intermediates, more preferably ethanol, ethylene or ethylene oxide.

i. Short Chain Intermediates:

One suitable example of transformation is a process in which a reactor converts carbon dioxide, water and electricity to methanol or ethanol and oxygen i.e. electrolysis. An example of this process is provided by Opus 12. Suitable processes are disclosed in WO21252535, WO17192787, WO20132064, WO20146402, WO19144135 and WO20112919.

An alternate suitable example of transformation is the conversion of carbon dioxide to ethanol using a catalyst of copper nanoparticles embedded in carbon spikes.

An alternate suitable example of transformation is the use of biological transformation which involves fermentation of the C, carbon by micro-organisms such as C₁-fixing bacteria to useful chemicals. This is alternatively known as gas fermentation, which is defined as the microbial conversion of gaseous substrates (e.g. CO, CO₂, and CH₄) to larger molecules.

The ability of micro-organisms to grow on CO as a sole carbon source was first discovered in 1903. This was later determined to be a property of organisms that use the acetyl coenzyme A (acetyl CoA) biochemical pathway of autotrophic growth (also known as the Woods-Ljungdahl pathway and the carbon monoxide dehydrogenase/acetyl CoA synthase (CODH/ACS) pathway). A large number of anaerobic organisms including carboxydotrophic, photosynthetic, methanogenic and acetogenic organisms have been shown to metabolize CO to various end products, namely CO₂, H₂, methane, n-butanol, acetate and ethanol. Preferably anaerobic bacteria such as those from the genus Clostridium are used to produce ethanol from carbon monoxide, carbon dioxide and hydrogen via the acetyl CoA biochemical pathway. There are a variety of microorganisms that can be used in a fermentation processes, particularly preferred are anaerobic bacteria such as Clostridium ljungdahlii strain PETC or ER12, which can be used to produce ethanol.

Exemplary gas fermentation processes are, but not limited to, syngas fermentation and aerobic methane fermentation as described (B. Geinitz et. al. Gas Fermentation Expands the Scope of a Process Network for Material Conversion. Chemie Ingenieur Technik. Vol 92, Issue 11, p. 1665-1679.). The microbes with the ability to convert CO and CO₂ fall primarily into the group of anaerobic acetogenic bacteria or aerobic carboxydotrophic bacteria, those able to convert methane are methanotrophs, which are usually aerobic methanothrophic bacteria. In this sense the term ‘gas fermentation’ is used loosely and includes the aerobic or anaerobic microbial or enzymatic conversion of organic matter preferably by syngas fermentation and aerobic methane fermentation.

Gas-fermentation can include multi-stage fermentation, mixed fermentation, co-cultivation, mixotrophy and thermophilic production. Multi-stage fermentation can broaden the portfolio of products obtained together with higher end-product concentrations. Mixed fermentation may help some strains to detoxify the environment from a toxic compound or reduce the concentration of a certain product allowing for a more efficient conversion of the gas or increased product yield (e.g. by a second strain). Mixotrophy is the use of two or more carbon/electron sources simultaneously by some microorganisms, where for example both CO₂ and organic substrates such as sugars are utilized together.

Thermophilic production (gas-fermentation at elevated temperatures by thermophilic strains, such as carboxydotrophic thermophiles) offers the advantages of reducing the risk of contamination. The gas-fermentation cultures may be defined or undefined, but preferably are in part or in the whole defined. Use of defined cultures offers the benefit of improved gas-fermentation end-product control.

Preferably the C1 molecules are transformed to short chain intermediates by gas fermentation. More preferably the C1 molecules are transformed to ethanol, ethylene or ethylene oxide by gas fermentation.

ii. Hydrocarbon Intermediates:

One suitable example is the Fischer-Tropsch process. Carbon dioxide and carbon monoxide can be chemically transformed to liquid hydrocarbons by the Fischer-Tropsch process, using hydrogen and a metal catalysis. Carbon dioxide feedstocks must first be converted to carbon monoxide by a reverse water gas shift reaction.

An alternate method for transformation into hydrocarbon intermediates solar photothermochemical alkane reverse combustion reactions. These are a one-step conversion of carbon dioxide and water into oxygen and hydrocarbons using a photothermochemical flow reactor.

Further examples of carbon capture technologies suitable to generate the ethanol stock for use in manufacturing ethoxy sub-units for use in the surfactants described herein are disclosed in WO 2007/117157, WO 2018/175481, WO 2019/157519 and WO 2018/231948.

Ingredients Comprising an Ethylene Oxide Group

The compositions described herein comprise ingredients comprising at least one ethoxylate unit and at least one carbon derived from carbon capture. Preferably the compositions comprise 0.01 to 15 wt. % ingredients comprising at least one ethoxylate unit and at least one carbon derived from carbon capture, more preferably 0.1 to 10 wt. % and most preferably 0.1 to 5 wt. % ingredients comprising at least one ethoxylate unit and at least one carbon derived from carbon capture by weight of the composition.

The carbon derived from carbon capture may be found anywhere within the chemical structure of the ingredient molecule. Preferably the carbon derived from carbon capture forms part of an alkyl chain or an ethoxylate group, preferably an ethoxylate group. Preferably at least 50 wt. % of the carbon atoms are obtained from carbon capture, more preferably at least 70 wt. % and most preferably all of the carbon atoms are obtained from carbon capture. Preferably, less than 90 wt. %, preferably less than 10 wt. % of the carbon atoms within the ingredient are obtained directly from virgin fossil fuels.

Carbon Located in Alkyl Chain:

Where the carbon derived from carbon capture is located in an alkyl chain, preferably on average at least 50 wt. % of the carbons in the alkyl chain are derived from carbon capture, more preferably at least 70 wt. %, most preferably all of the carbons in the alkyl chain are derived from carbon capture.

As described above, suitable carbon chains can be obtained from a Fischer-Tropsh reaction. The feedstock for the Fischer-Tropsch may be 100% carbon obtained from carbon capture or may be a mixture of carbon from different sources. For example carbon gases from natural gas could be used, although this is not preferable. Preferably the alkyl chain comprises less than 10 wt. % carbon obtained directly from virgin fossil fuels more preferably the alky chain comprises no carbon obtained directly from virgin fossil fuels.

Alternatively, the alkyl chain may be a combination of alkyl groups from carbon capture and alky groups from triglycerides, preferably triglycerides are obtained from plants, such as palm, rice, rice bran, sunflower, coconut, rapeseed, maze, soy, cottonseed, olive oil, etc.

Carbon Located in Ethoxylate Group:

Where the carbon derived from carbon capture is located on an ethoxylate group, preferably on average at least 50 wt. % of the ethoxylate carbons in the molecule are derived from carbon capture, more preferably at least 70 wt. %, most preferably all the ethoxylate carbons in the molecule are derived from carbon capture. In a single ethoxylate monomer, one or both carbons may be carbons obtained from carbon capture, preferably both carbons are carbons obtained from carbon capture. Preferably, more than 10 wt. %, preferably more than 90 wt. % of the ethoxylate groups comprise carbon atoms obtained from carbon capture based sources. Alternate sources of carbon include plant based carbon, for example ethanol obtained from the fermentation of sugar and starch (i.e. ‘bio’ ethanol). The ethoxylate groups may comprise carbons from virgin fossil fuels, however this is not preferable. Preferably, less than 90 wt. %, preferably less than 10 wt. % of the ethoxylate groups comprise carbon atoms obtained directly from virgin fossil fuels. To produce ethoxylates from carbon capture, first ethanol produced as outlined above is dehydrated to ethylene. This is a common industrial process. The ethylene is then oxidised to form ethylene oxide.

Depending on the desired material, different routes are available.

If an alcohol ethoxylate is desired, the ethylene oxide can be reacted with a long chain fatty alcohol via a polymerisation type reaction. This process is commonly referred to as ethoxylation and gives rise to alcohol ethoxylates. Preferably the long chain fatty alcohol comprises carbon from carbon capture and/or from a plant source. More preferably the long chain fatty alcohol comprises only carbon from carbon capture and/or from a plant source. Most preferably and fatty alcohol comprises only carbon from carbon capture.

If a polyethylene glycol is desired, the ethylene oxide can be polymerised, for example in the presence of water and a catalyst to yield a polyethylene glycol chain.

Preferably all carbons within the ingredient molecule are derived from a plant source or carbon capture. Most preferably, all carbons are derived from carbon capture.

Preferred ethoxylated materials include: fatty acid ethoxylates, fatty amine ethoxylates, fatty alcohol ethoxylates, nonylphenol ethoxylates, alkyl phenol ethoxylate, amide ethoxylates, Sorbitan(ol) ester ethoxylates, glyceride ethoxylates (castor oil or hydrogenated castor oil ethoxylates) and mixtures thereof.

Preferably the ingredients comprising at least one ethoxylate unit and at least one carbon derived from carbon capture is selected from alcohol ethoxylates, polyethylene glycols and materials substituted with polyethylene glycols.

Alcohol Ethoxylates:

More preferably, are alcohol ethoxylates, most preferably alcohol ethoxylates having a general formula:

R—Y—(C₂H₄O)ᵣ—CH₂—CH₂—OH

Wherein R is an alkyl chain. When the ingredient comprising at least one ethoxylate unit and at least one carbon derived from carbon capture is an alcohol ethoxylate, the carbon obtained from carbon capture may be located in the alky chain or the ethoxylate group. Preferably both the alkyl chain and ethoxylate comprise carbon obtained from carbon capture.

R is preferably 8 to 60, more preferably 10 to 25, even more preferably 12 to 20 and most preferably 16-18.

Y is selected from:
—O—, —C(O)O—, —C(O)N(R)— or —C(O)N(R)R—

and is preferably —O—

Z is preferably 2 to 100, more preferably 5 to 50, most preferably 10 to 40, calculated as a molar average.

Particularly preferably R is 16-18 and Z is 20-30.

These ingredients are particularly advantageous in so called dilute at home products, in which they aid the spontaneous mixing on the concentrated product and water, when the consumer dilutes at home.

Polyethylene Glycols:

Polyethylene glycols (PEGs) have a general formula:

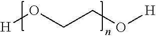

n is preferably 2 to 200, more preferably 2 to 100, even more preferably 2 to 40, 2 to 30 and most preferably 2 to 20.

The weight average molecular weight of the PEG is preferably 100 to 1000, more preferably 100 to 800, most preferably 100 to 600.

The PEG may solely comprise carbon from carbon capture or may comprise carbon from carbon capture in combination with carbon from other sources, as described above.

Materials Substituted with Polyethylene Glycols:

These are materials obtained by the reaction of PEG or ethylene oxide with another ingredient. For example, the reaction of ethylene oxide and castor oil results in a PEG hydrogenated castor oil.

Preferably these materials are hydrogenated castor oils. Preferably the castor oil is hydrogenated with 10 to 80 moles of ethylene oxide, preferably 20 to 60 moles of ethylene oxide. A particularly preferable ingredient is PEG 40 hydrogenated castor oil.

Percent Modern Carbon

The percentage modern carbon (pMC) level is based on measuring the level of radiocarbon (C14) which is generated in the upper atmosphere from where it diffuses, providing a general background level in the air. The level of C14, once captured (e.g. by biomass) decreases over time, in such a way that the amount of C14 is essentially depleted after 45,000 years. Hence the C14 level of fossil-based carbons, as used in the conventional petrochemical industry is virtually zero.

A pMC value of 100% biobased or biogenic carbon would indicate that 100% of the carbon came from plants or animal by-products (biomass) living in the natural environment (or as captured from the air) and a value of 0% would mean that all of the carbon was derived from petrochemicals, coal and other fossil sources. A value between 0-100% would indicate a mixture. The higher the value, the greater the proportion of naturally sourced components in the material, even though this may include carbon captured from the air.

The pMC level can be determined using the % Biobased Carbon Content ASTM D6866-20 Method B, using a National Institute of Standards and Technology (NIST) modern reference standard (SRM 4990C). Such measurements are known in the art are performed commercially, such as by Beta Analytic Inc. (USA). The technique to measure the C14 carbon level is known since decades and most known from carbon-dating archaeological organic findings.

The particular method used by Beta Analytic Inc., which is the preferred method to determine pMC includes the following: Radiocarbon dating is performed by Accelerator Mass Spectrometry (AMS). The AMS measurement is done on graphite produced by hydrogen reduction of the CO₂ sample over a cobalt catalyst. The CO₂ is obtained from the combustion of the sample at 800° C.+ under a 100% oxygen atmosphere. The CO₂ is first dried with methanol/dry ice then collected in liquid nitrogen for the subsequent graphitization reaction. The identical reaction is performed on reference standards, internal QA samples, and backgrounds to ensure systematic chemistry. The pMC result is obtained by measuring sample C14/C13 relative to the C14/C13 in Oxalic Acid II (NIST-4990C) in one of Beta Analytic's multiple in-house particle accelerators using SNICS ion source. Quality assurance samples are measured along with the unknowns and reported separately in a “QA report”. The radiocarbon dating lab requires results for the QA samples to fall within expectations of the known values prior to accepting and reporting the results for any given sample. The AMS result is corrected for total fractionation using machine graphite d13C. The d13C reported for the sample is obtained by different ways depending upon the sample material. Solid organics are sub-sampled and converted to CO₂ with an elemental analyzer (EA). Water and carbonates are acidified in a gas bench to produce CO₂. Both the EA and the gas bench are connected directly to an isotope-ratio mass spectrometer (IRMS). The IRMS performs the separation and measurement of the CO₂ masses and calculation of the sample d13C.

In one embodiment, the ingredient comprising at least one ethoxylate unit and at least one carbon derived from carbon capture comprises carbons from point source carbon capture. These ingredients preferably have a pMC of 0 to 10%.

In an alternate embodiment, the ingredient comprising at least one ethoxylate unit and at least one carbon derived from carbon capture comprises carbons from direct air capture. These ingredients preferably have a pMC of 90 to 100%.

Perfume

The compositions of the present invention comprise free perfume.

Free perfume may be present at a level selected from: less than 10 wt. %, less than 8 wt. %, and less than 5 wt. %, by weight of the spray composition. Free perfume may be present at a level selected from: more than 0.0001 wt. %, more than 0.001 wt. %, and more than 0.01 wt. %, by weight of the spray composition. Suitably free perfume is present in the spray composition in an amount selected from the range of from about 0.0001 wt. % to about 10 wt. %, preferably from about 0.001 wt. % to about 8 wt. %, more preferably from about 0.01 wt. % to about 5 wt. %, by weight of the spray composition.

Useful perfume components may include materials of both natural and synthetic origin. They include single compounds and mixtures. Specific examples of such components may be found in the current literature, e.g., in Fenaroli's Handbook of Flavor Ingredients, 1975, CRC Press; Synthetic Food Adjuncts, 1947 by M. B. Jacobs, edited by Van Nostrand; or Perfume and Flavor Chemicals by S. Arctander 1969, Montclair, N.J. (USA). These substances are well known to the person skilled in the art of perfuming, flavouring, and/or aromatizing consumer products.

Particularly preferred perfume components are blooming perfume components and substantive perfume components. Blooming perfume components are defined by a boiling point less than 250° C. and a Log P greater than 2.5. Substantive perfume components are defined by a boiling point greater than 250° C. and a Log P greater than 2.5. Preferably a perfume composition will comprise a mixture of blooming and substantive perfume components. The perfume composition may comprise other perfume components.

It is commonplace for a plurality of perfume components to be present in a free oil perfume composition. In the compositions for use in the present invention it is envisaged that there will be three or more, preferably four or more, more preferably five or more, most preferably six or more different perfume components. An upper limit of 300 perfume components may be applied.

The free perfume of the present invention is preferably in the form of an emulsion. The particle size of the emulsion can be in the range from about 1 nm to 30 microns and preferably from about 100 nm to about 20 microns. The particle size is measured as a volume mean diameter, D[4,3], this can be measured using a Malvern Mastersizer 2000 from Malvern instruments.

Free oil perfume forms an emulsion in the present compositions. The emulsions may be formed outside of the composition or in situ. When formed in situ, at least one emulsifier is preferably added with the free oil perfume to stabilise the emulsion. Preferably the emulsifier is anionic or non-ionic. Examples suitable anionic emulsifiers for the free oil perfume are alkylarylsulphonates, e.g., sodium dodecylbenzene sulphonate, alkyl sulphates e.g., sodium lauryl sulphate, alkyl ether sulphates, e.g., sodium lauryl ether sulphate nEO, where n is from 1 to 20 alkylphenol ether sulphates, e.g., octylphenol ether sulphate nEO where n is from 1 to 20, and sulphosuccinates, e.g., sodium dioctylsulphosuccinate. Examples of suitable nonionic surfactants used as emulsifiers for the free oil perfume are alkylphenol ethoxylates, e.g., nonylphenol ethoxylate nEO, where n is from 1 to 50, alcohol ethoxylates, e.g., lauryl alcohol nEO, where n is from 1 to 50, ester ethoxylates, e.g., polyoxyethylene monostearate where the number of oxyethylene units is from 1 to 30 and PEG-40 hydrogenated castor oil.

The compositions of the present invention may comprise one or more perfume compositions. The perfume compositions may be in the form of a mixture of free perfumes compositions or a mixture of encapsulated and free oil perfume compositions. Preferably some of the perfume components are contained in a microcapsule. Where encapsulated perfume are present, suitable encapsulating material, may comprise, but are not limited to; aminoplasts, proteins, polyurethanes, polyacrylates, polymethacrylates, polysaccharides, polyamides, polyolefins, gums, silicones, lipids, modified cellulose, polyphosphate, polystyrene, polyesters or combinations thereof.

Perfume components contained in a microcapsule may comprise odiferous materials and/or pro-fragrance materials.

Particularly preferred perfume components contained in a microcapsule are blooming perfume components and substantive perfume components. Blooming perfume components are defined by a boiling point less than 250° C. and a Log P greater than 2.5. Substantive perfume components are defined by a boiling point greater than 250° C. and a Log P greater than 2.5. Preferably a perfume composition will comprise a mixture of blooming and substantive perfume components. The perfume composition may comprise other perfume components.

It is commonplace for a plurality of perfume components to be present in a microcapsule. In the compositions for use in the present invention it is envisaged that there will be three or more, preferably four or more, more preferably five or more, most preferably six or more different perfume components in a microcapsule. An upper limit of 300 perfume ingredients may be applied.

Encapsulated perfume may preferably be present in an amount from 0.01 to 20 wt. %, more preferably 0.1 to wt. 15%, more preferably from 0.1 to 10 wt. %, even more preferably from 0.1 to 6.0 wt. %, most preferably from 0.5 to 6.0 wt. %, based on the total weight of the composition.

Malodour Ingredients

Compositions of the present invention preferably comprise anti-malodour ingredient(s). Malodour ingredients may be in addition to traditional free perfume ingredients.

Anti-malodour agent may be present at a level selected from: less than 20%, less than 10%, and less than 5%, by weight of the spray composition. Suitably anti-malodour agent are present in the spray composition in an amount selected from the range of from about 0.01% to about 5%, preferably from about 0.1% to about 3%, more preferably from about 0.5% to about 2%, by weight of the spray composition.

Any suitable anti-malodour agent may be used. Indeed, an anti-malodour effect may be achieved by any compound or product that is effective to “trap”, “absorb” or “destroy” odour molecules to thereby separate or remove odour from the garment or act as a “malodour counteractant”. The odour control agent may be selected from the group consisting of: uncomplexed cyclodextrin; odour blockers; reactive aldehydes; flavanoids; zeolites; activated carbon; a mixture of zinc ricinoleate or a solution thereof and a substituted monocyclic organic compound; and mixtures thereof.

As noted above, a suitable anti-malodour agent is cyclodextrin, suitably water soluble uncomplexed cyclodextrin. Suitably cyclodextrin is present at a level selected from 0.01% to 5%, 0.1% to 4%, and 0.5% to 2% by weight of the spray composition.

As used herein, the term “cyclodextrin” includes any of the known cyclodextrins such as unsubstituted cyclodextrins containing from six to twelve glucose units, especially, alpha-cyclodextrin, beta-cyclodextrin, gamma-cyclodextrin and/or their derivatives and/or mixtures thereof. The alpha-cyclodextrin consists of six glucose units, the beta-cyclodextrin consists of seven glucose units, and the gamma-cyclodextrin consists of eight glucose units arranged in donut-shaped rings.

Preferably, the cyclodextrins are highly water-soluble such as, alpha-cyclodextrin and/or derivatives thereof, gamma-cyclodextrin and/or derivatives thereof, derivatised beta-cyclodextrins, and/or mixtures thereof. The derivatives of cyclodextrin consist mainly of molecules wherein some of the OH groups are converted to OR groups. Cyclodextrin derivatives include, e.g., those with short chain alkyl groups such as methylated cyclodextrins, and ethylated cyclodextrins, wherein R is a methyl or an ethyl group; those with hydroxyalkyl substituted groups, such as hydroxypropyl cyclodextrins and/or hydroxyethyl cyclodextrins, wherein R is a —CH2-CH(OH)—CH3 or a —CH2CH2-OH group; branched cyclodextrins such as maltose-bonded cyclodextrins; cationic cyclodextrins such as those containing 2-hydroxy-3-(dimethylamino)propyl ether, wherein R is CH2-CH(OH)—CH2-N(CH3)2 which is cationic at low pH; quaternary ammonium, e.g., 2-hydroxy-3-(trimethylammonio)propyl ether chloride groups, wherein R is CH2-CH(OH)—CH2-N+(CH3)3Cl—; anionic cyclodextrins such as carboxymethyl cyclodextrins, cyclodextrin sulfates, and cyclodextrin succinylates; amphoteric cyclodextrins such as carboxymethyl/quaternary ammonium cyclodextrins; cyclodextrins wherein at least one glucopyranose unit has a 3-6-anhydro-cyclomalto structure, e.g., the mono-3-6-anhydrocyclodextrinse.

Highly water-soluble cyclodextrins are those having water solubility of at least about 10 g in 100 ml of water at room temperature, preferably at least about 20 g in 100 ml of water, more preferably at least about 25 g in 100 ml of water at room temperature. The availability of solubilized, uncomplexed cyclodextrins is essential for effective and efficient odour control performance. Solubilized, water-soluble cyclodextrin can exhibit more efficient odour control performance than non-water-soluble cyclodextrin when deposited onto surfaces, especially fabric.

Examples of preferred water-soluble cyclodextrin derivatives suitable for use herein are hydroxypropyl alpha-cyclodextrin, methylated alpha-cyclodextrin, methylated beta-cyclodextrin, hydroxyethyl beta-cyclodextrin, and hydroxypropyl beta-cyclodextrin. Hydroxyalkyl cyclodextrin derivatives preferably have a degree of substitution of from about 1 to about 14, more preferably from about 1.5 to about 7, wherein the total number of OR groups per cyclodextrin is defined as the degree of substitution. Methylated cyclodextrin derivatives typically have a degree of substitution of from about 1 to about 18, preferably from about 3 to about 16. A known methylated beta-cyclodextrin is heptakis-2,6-di-O-methyl-β-cyclodextrin, commonly known as DIMEB, in which each glucose unit has about 2 methyl groups with a degree of substitution of about 14. A preferred, more commercially available, methylated beta-cyclodextrin is a randomly methylated beta-cyclodextrin, commonly known as RAMEB, having different degrees of substitution, normally of about 12.6. RAMEB is more preferred than DIMEB, since DIMEB affects the surface activity of the preferred surfactants more than RAMEB. The preferred cyclodextrins are available, e.g., from Cerestar U.S.A., Inc. and Wacker Chemicals (U.S.A.), Inc.

In embodiments mixtures of cyclodextrins are used.

“Odour blockers” can be used as an anti-malodour agent to mitigate the effects of malodours. Non-limiting examples of odour blockers include 4-cyclohexyl-4-methyl-2-pentanone, 4-ethylcyclohexyl methyl ketone, 4-isopropylcyclohexyl methyl ketone, cyclohexyl methyl ketone, 3-methylcyclohexyl methyl ketone, 4-tert.-butylcyclohexyl methyl ketone, 2-methyl-4-tert.butylcyclohexyl methyl ketone, 2-methyl-5-isopropylcyclohexyl methyl ketone, 4-methylcyclohexyl isopropyl ketone, 4-methylcyclohexyl secbutyl ketone, 4-methylcyclohexyl isobutyl ketone, 2,4-dimethylcyclohexyl methyl ketone, 2,3-dimethylcyclohexyl methyl ketone, 2,2-dimethylcyclohexyl methyl ketone, 3,3-dimethylcyclohexyl methyl ketone, 4,4-dimethylcyclohexyl methyl ketone, 3,3,5-trimethylcyclohexyl methyl ketone, 2,2,6-trimethylcyclohexyl methyl ketone, 1-cyclohexyl-1-ethyl formate, 1-cyclohexyl-1-ethyl acetate, 1-cyclohexyl-1-ethyl propionate, 1-cyclohexyl-1-ethyl isobutyrate, 1-cyclohexyl-1-ethyl n-butyrate, 1-cyclohexyl-1-propyl acetate, 1-cyclohexyl-1-propyl n-butyrate, 1-cyclohexyl-2-methyl-1-propyl acetate, 2-cyclohexyl-2-propyl acetate, 2-cyclohexyl-2-propyl propionate, 2-cyclohexyl-2-propyl isobutyrate, 2-cyclohexyl-2-propyl n-butyrate, 5,5-dimethyl-1,3-cyclohexanedione (dimedone), 2,2-dimethyl-1,3-dioxane-4,6-dione (Meldrum's acid), spiro-[4.5]-6,10-dioxa-7,9-dioxodecane, spiro-[5.5]-1,5-dioxa-2,4-dioxoundecane, 2,2-hydroxymethyl-1,3-dioxane-4,6-dione and 1,3-cyclohexadione. Odour blockers are disclosed in more detail in U.S. Pat. Nos. 4,009,253; 4,187,251; 4,719,105; 5,441,727; and 5,861,371, incorporated herein by reference.

Reactive aldehydes can be used as anti-malodour agent to mitigate the effects of malodours. Examples of suitable reactive aldehydes include Class I aldehydes and Class II aldehydes. Examples of Class I aldehydes include anisic aldehyde, o-allyl-vanillin, benzaldehyde, cuminic aldehyde, ethylaubepin, ethyl-vanillin, heliotropin, tolyl aldehyde, and vanillin. Examples of Class II aldehydes include 3-(4′-tert.butylphenyl)propanal, 2-methyl-3-(4′-tertbutylphenyl)propanal, 2-methyl-3-(4′-isopropylphenyl)propanal, 2,2-dimethyl-3-(4-ethylphenyl)propanal, cinnamic aldehyde, a-amyl-cinnamic aldehyde, and a-hexyl-cinnamic aldehyde. These reactive aldehydes are described in more detail in U.S. Pat. No. 5,676,163. Reactive aldehydes, when used, can include a combination of at least two aldehydes, with one aldehyde being selected from acyclic aliphatic aldehydes, non-terpenic aliphatic aldehydes, non-terpenic alicyclic aldehydes, terpenic aldehydes, aliphatic aldehydes substituted by an aromatic group and bifunctional aldehydes; and the second aldehyde being selected from aldehydes possessing an unsaturation alpha to the aldehyde function conjugated with an aromatic ring, and aldehydes in which the aldehyde group is on an aromatic ring. This combination of at least two aldehydes is described in more detail in WO 00/49120. As used herein, the term “reactive aldehydes” further encompasses deodourizing materials that are the reaction products of (i) an aldehyde with an alcohol, (ii) a ketone with an alcohol, or (iii) an aldehyde with the same or different aldehydes. Such deodourizing materials can be: (a) an acetal or hemiacetal produced by means of reacting an aldehyde with a carbinol; (b) a ketal or hemiketal produced by means of reacting a ketone with a carbinol; (c) a cyclic triacetal or a mixed cyclic triacetal of at least two aldehydes, or a mixture of any of these acetals, hemiacetals, ketals, hemiketals, or cyclic triacetals. These deodorizing perfume materials are described in more detail in WO 01/07095 incorporated herein by reference.

Flavanoids can also be used as anti-malodour agent. Flavanoids are compounds based on the C6-C3-C6 flavan skeleton. Flavanoids can be found in typical essential oils. Such oils include essential oil extracted by dry distillation from needle leaf trees and grasses such as cedar, Japanese cypress, eucalyptus, Japanese red pine, dandelion, low striped bamboo and cranesbill and can contain terpenic material such as alpha-pinene, beta-pinene, myrcene, phencone and camphene. Also included are extracts from tea leaf. Descriptions of such materials can be found in JP 02284997 and JP 04030855 incorporated herein by reference.

Metallic salts can also be used as anti-malodour agents for malodour control benefits. Examples include metal salts of fatty acids. Ricinoleic acid is a preferred fatty acid. Zinc salt is a preferred metal salt. The zinc salt of ricinoleic acid is especially preferred. A commercially available product is TEGO Sorb A30 ex Evonik. Further details of suitable metallic salts is provided below.

Zeolites can be used as anti-malodour agent. A useful class of zeolites is characterized as “intermediate” silicate/aluminate zeolites. The intermediate zeolites are characterized by SiO₂/AlO₂ molar ratios of less than about 10. Preferably the molar ratio of SiO₂/AlO₂ ranges from about 2 to about 10. The intermediate zeolites can have an advantage over the “high” zeolites. The intermediate zeolites have a higher affinity for amine-type odours, they are more weight efficient for odour absorption because they have a larger surface area, and they are more moisture tolerant and retain more of their odour absorbing capacity in water than the high zeolites. A wide variety of intermediate zeolites suitable for use herein are commercially available as Valfor® CP301-68, Valfor® 300-63, Valfor® CP300-35, and Valfor® CP300-56, available from PQ Corporation, and the CBV100® series of zeolites from Conteka. Zeolite materials marketed under the trade name Abscents® and Smellrite®, available from The Union Carbide Corporation and UOP are also preferred. Such materials are preferred over the intermediate zeolites for control of sulfur-containing odours, e.g., thiols, mercaptans. Suitably the zeolite material has a particle size of less than about 10 microns and is present in the spray composition at a level of less than about 1% by weight of the spray composition.

Activated carbon is another suitable anti-malodour agent. Suitable carbon material is a known absorbent for organic molecules and/or for air purification purposes. Often, such carbon material is referred to as “activated” carbon or “activated” charcoal. Such carbon is available from commercial sources under such trade names as; Calgon-Type CPG®; Type PCB®; Type SGL®; Type CAL®; and Type OL®. Suitably the activated carbon preferably has a particle size of less than about 10 microns and is present in the spray composition at a level of less than about 1% by weight of the spray composition.

Exemplar anti-malodour agents are as follows.

ODOBAN™ is manufactured and distributed by Clean Central Corp. of Warner Robins, Ga. Its active ingredient is alkyl (C14 50%, C12 40% and C16 10%) dimethyl benzyl ammonium chloride which is an antibacterial quaternary ammonium compound. The alkyl dimethyl benzyl ammonium chloride is in a solution with water and isopropanol. Another product by Clean Control Corp. is BIOODOUR CONTROL™ which includes water, bacterial spores, alkylphenol ethoxylate and propylene glycol.

ZEOCRYSTAL FRESH AIR MIST™ is manufactured and distributed by Zeo Crystal Corp. (a/k/a American Zeolite Corporation) of Crestwood, Ill. The liquid comprises chlorites, oxygen, sodium, carbonates and citrus extract, and may comprise zeolite.

The odour control agent may comprise a “malodour counteractant” as described in US2005/0113282A1 by which is hereby incorporated by reference. In particular this malodour counteractant may comprise a mixture of zinc ricinoleate or a solution thereof and a substituted monocyclic organic compound as described at page 2, paragraph 17 whereby the substituted monocyclic organic compound is in the alternative or in combination one or more of:
1-cyclohexylethan-1-yl butyrate;
1-cyclohexylethan-1-yl acetate;
1-cyclohexylethan-1-ol;
1-(4′-methylethyl) cyclohexylethan-1-yl propionate; and
2′-hydroxy-1′-ethyl(2-phenoxy)acetate.

Synergistic combinations of malodour counteractants as disclosed at paragraphs 38-49 are suitable, for example, the compositions comprising:
(i) from about 10 to about 90 parts by weight of at least one substituted monocyclic organic compound-containing material which is:
(a) 1-cyclohexylethan-1-yl butyrate having the structure:

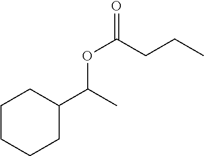

(b) 1-cyclohexylethan-1-yl acetate having the structure:

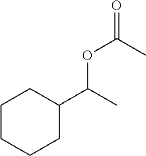

(c) 1-cyclohexylethan-1-ol having the structure:

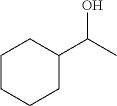

(d) 1-(4′-methylethyl)cyclohexylethan-1-yl propionate having the structure:

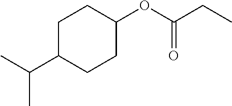

and
(e) 2′-hydroxy-1′-ethyl(2-phenoxy)acetate having the structure:

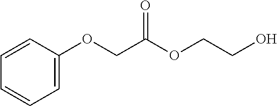 [SMILES: O=C(COc1ccccc1)OCCO]

and (ii) from about 90 to about 10 parts by weight of a zinc ricinoleate-containing composition which is zinc ricinoleate and/or solutions of zinc ricinoleate containing greater than about 30% by weight of zinc ricinoleate. Preferably, the aforementioned zinc ricinoleate-containing compositions are mixtures of about 50% by weight of zinc ricinoleate and about 50% by weight of at least one 1-hydroxy-2-ethoxyethyl ether of a More specifically, a preferred composition useful in combination with the zinc ricinoleate component is a mixture of:
(A) 1-cyclohexylethan-1-yl butyrate;
(B) 1-cyclohexylethan-1-yl acetate; and
(C) 1-(4′-methylethyl)cyclohexylethan-1-yl propionate.

More preferably, the weight ratio of components of the immediately-aforementioned zinc riconoleate-containing mixture is one where the zinc ricinoleate-containing composition: 1-cyclohexylethan-1-yl butyrate: 1-cyclohexylethan-1-yl acetate: 1-(4′-methylethyl)-cyclohexylethan-1-yl propionate is about 2:1:1:1.

Another preferred composition useful in combination with the zinc ricinoleate component or solution is a mixture of:
(A) 1-cyclohexylethan-1-yl acetate; and
(B) 1-(4′-methylethyl)cyclohexylethan-1-yl propionate.

More preferably, the weight ratio of components of the immediately-aforementioned zinc riconoleate mixture is one where the zinc ricinoleate-containing composition: 1-cyclohexylethan-1-yl acetate: 1-(4′-methylethyl)cyclohexylethan-1-yl propionate is about 3:1:1.

The anti-malodour materials of the present invention may be ‘free’ in the composition or they may be encapsulated. Suitable encapsulating material, may comprise, but are not limited to; aminoplasts, proteins, polyurethanes, polyacrylates, polymethacrylates, polysaccharides, polyamides, polyolefins, gums, silicones, lipids, modified cellulose, polyphosphate, polystyrene, polyesters or combinations thereof. Particularly preferred encapsulating materials are aminoplasts, such as melamine formaldehyde or urea formaldehyde. The microcapsules of the present invention can be friable microcapsules and/or moisture activated microcapsules. By friable, it is meant that the perfume microcapsule will rupture when a force is exerted. By moisture activated, it is meant that the perfume is released in the presence of water.

To the extent any material described herein as an odour control agent might also be classified as another component described herein, for purposes of the present invention, such material shall be classified as an odour control agent.

Lubricants:

The spray compositions of the present invention preferably comprise lubricants. Lubricants may be silicone based lubricants or non-silicone based lubricants.

Lubricant materials may be present at a level selected from: less than 10%, less than 8%, and less than 6%, by weight of the spray composition. Lubricant materials may be present at a level selected from: more than 0.5%, more than 1%, and more than 1.5%, by weight of the spray composition. Suitably Lubricant materials are present in the spray composition in an amount selected from the range of from about 0.5% to about 10%, preferably from about 1% to about 8%, more preferably from about 1.5% to about 6%, by weight of the spray composition. Any lubricants are present in addition to the ester oil.

Examples of non-silicone based lubricants include fabric softening quaternary ammonium compounds, amines, fatty acid esters, clays, waxes, polyolefins, polymer latexes, synthetic and natural oils.

Preferably the lubricant is a fabric softening quaternary ammonium compounds or a silicone-based lubricant. Most preferably the lubricant is a silicone based lubricant.

For the purposes of the present invention, fabric softening quaternary ammonium compounds are so called “ester quats”. Particularly preferred materials are the ester-linked triethanolamine (TEA) quaternary ammonium compounds comprising a mixture of mono-, di- and tri-ester linked components.

A first group of quaternary ammonium compounds (QACs) suitable for use in the present invention is represented by formula (I):

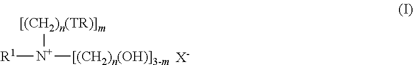

wherein each R is independently selected from a C5 to C35 alkyl or alkenyl group; R1 represents a C1 to C4 alkyl, C2 to C4 alkenyl or a C1 to C4 hydroxyalkyl group; T may be either O—CO. (i.e. an ester group bound to R via its carbon atom), or may alternatively be CO—O (i.e. an ester group bound to R via its oxygen atom); n is a number selected from 1 to 4; m is a number selected from 1, 2, or 3; and X− is an anionic counter-ion, such as a halide or alkyl sulphate, e.g. chloride or methylsulfate. Di-esters variants of formula I (i.e. m=2) are preferred and typically have mono- and tri-ester analogues associated with them. Such materials are particularly suitable for use in the present invention.

Suitable actives include soft quaternary ammonium actives such as Stepantex VT90, Rewoquat WE18 (ex-Evonik) and Tetranyl L1/90N, Tetranyl L190 SP and Tetranyl L190 S (all ex-Kao).

A second group of QACs suitable for use in the invention is represented by formula (III):

(R¹)₂—N⁺—[(CH₂)ₙT-R²]₂X⁻ (III)

wherein each R1 group is independently selected from C1 to C4 alkyl, or C2 to C4 alkenyl groups; and wherein each R2 group is independently selected from C8 to C28 alkyl or alkenyl groups; and n, T, and X− are as defined above. Preferred materials of this third group include bis(2-tallowoyloxyethyl)dimethyl ammonium chloride, partially hardened and hardened versions thereof.

A particular example of the second group of QACs is represented the by the formula:

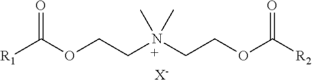

A second group of QACs suitable for use in the invention are represented by formula (V)

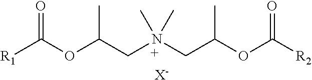

R1 and R2 are independently selected from C10 to C22 alkyl or alkenyl groups, preferably C14 to C20 alkyl or alkenyl groups. X− is as defined above.

The iodine value of the quaternary ammonium fabric conditioning material is preferably from 0 to 80, more preferably from 0 to 60, and most preferably from 20 to 50.

Silicones and their chemistry are described in, for example in The Encyclopedia of Polymer Science, volume 11, p 765.

Silicones suitable for the present invention are fabric softening silicones. Non-limiting examples of such silicones include:
Non-functionalised silicones such as polydimethylsiloxane (PDMS),
Functionalised silicones such as alkyl (or alkoxy) functionalised, alkylene oxide functionalised, amino functionalised, phenyl functionalised, hydroxy functionalised, polyether functionalised, acrylate functionalised, siliconhydride functionalised, carboxy functionalised, phosphate functionalised, sulphate functionalised, phosphonate functionalised, sulphonic functionalised, betaine functionalised, quarternized nitrogen functionalised and mixtures thereof.
Copolymers, graft co-polymers and block co-polymers with one or more different types of functional groups such as alkyl, alkylene oxide, amino, phenyl, hydroxy, polyether, acrylate, siliconhydride, carboxy, phosphate, sulphonic, phosphonate, betaine, quarternized nitrogen and mixtures thereof.

Suitable non-functionalised silicones have the general formula:

R₁—Si(R₃)₂—O—[—Si(R₃)₂—O—]ₓ—Si(R₃)₂—R₂
R₁=hydrogen, methyl, methoxy, ethoxy, hydroxy, propoxy, and aryloxy group.
R₂=hydrogen, methyl, methoxy, ethoxy, hydroxy, propoxy, and aryloxy group.
R₃=alkyl, aryl, hydroxy, or hydroxyalkyl group, and mixtures thereof

A suitable example of a PDMS polymer is E22 ex. Wacker Chemie.

Suitable functionalised silicones may be anionic, cationic, or non-ionic functionalised silicones. The functional group(s) on the functionalised silicones are preferably located in pendent positions on the silicone i.e. the composition comprises functionalised silicones wherein the functional group(s) are located in a position other than at the end of the silicone chain. The terms ‘terminal position’ and ‘at the end of the silicone chain’ are used to indicate the terminus of the silicone chain.

When the silicones are linear in nature, there are two ends to the silicone chain. In this case the anionic silicone preferably contains no functional groups located on a terminal position of the silicone. When the silicones are branched in nature, the terminal position is deemed to be the two ends of the longest linear silicone chain. Preferably no functional group(s) are located on the terminus of the longest linear silicone chain.

Preferred functionalised silicones are those that comprise the anionic group at a mid-chain position on the silicone. Preferably the functional group(s) of the functionalised silicone are located at least five Si atoms from a terminal position on the silicone. Preferably the functional groups are distributed randomly along the silicone chain.

For best performance, it is preferred that the silicone is selected from: carboxy functionalised silicone; anionic functionalised silicone; non-functionalised silicone; and mixtures thereof. More preferably, the silicone is selected from: carboxy functionalised silicone; amino functionalised silicone; polydimethylsiloxane (PDMS) and mixtures thereof. Preferred features of each of these materials are outlined herein. Most preferably the silicone is selected from amino functionalised silicones; polydimethylsiloxane (PDMS) and mixtures thereof.

A carboxy functionalised silicone may be present as a carboxylic acid or an carbonate anion and preferably has a carboxy group content of at least 1 mol % by weight of the silicone polymer, preferably at least 2 mol %. Preferably the carboxy group(s) are located in a pendent position, more preferably located at least five Si atoms from a terminal position on the silicone. Preferably the caboxy groups are distributed randomly along the silicone chain. Examples of suitable carboxy functional silicones include FC 220 ex. Wacker Chemie and X22-3701E ex. Shin Etsu.

An amino functionalised silicone means a silicone containing at least one primary, secondary or tertiary amine group, or a quaternary ammonium group. The primary, secondary, tertiary and/or quaternary amine groups are preferably located in a pendent position, more preferably located at least five Si atoms from a terminal position on the silicone. Aminosilicones suitable for use in the invention will preferably have an amine content of the composition of 0.001 to 3 meq/g, more preferably 0.01 to 2.5 meq/g, most preferably 0.05 to 1.5 meq/g, which is measured as the consumption of 1 N hydrochloric acid in ml/g by the composition on titration to the neutral point. Preferably the amino groups are distributed randomly along the silicone chain. Examples of suitable amino functional silicones include FC222 ex. Wacker Chemie and EC218 ex. Wacker Chemie.

The molecular weight of the silicone polymer is preferably from 1,000 to 500,000, more preferably from 2,000 to 250,000 even more preferably from 5,000 to 200,000.

The silicone of the present invention is in the form of an emulsion. Silicones are preferably emulsified prior to addition to the present compositions. Silicone compositions are generally supplied from manufacturers in the form of emulsions. The average particle size of the emulsion is in the range from about 1 nm to 150 nm, preferably 1 nm to 100 nm. This may be referred to as a micro emulsion. The particle size is measured as a volume mean diameter, D[4,3], this can be measured using a Malvern Mastersizer 2000 from Malvern instruments.

Setting Polymers

The fabric spray of the present invention may preferably further comprise one or more setting polymers. “setting polymer” means any polymer which refers to polymer having properties of film-formation, adhesion, or coating deposited on a surface on which the polymer is applied.

The setting polymer may be present at a level selected from: less than 10%, less than 7.5%, and less than 5%, by weight of the spray composition. The setting polymer may be present at a level selected from: more than 0.5%, more than 1%, and more than 1.5%, by weight of the spray composition. Suitably the setting polymer is present in the spray composition in an amount selected from the range of from about 0.5% to about 10%, preferably from about 1% to about 7.5%, more preferably from about 1.5% to about 5%, by weight of the fabric spray composition.

The molecular weight of the setting polymer is preferably from 1,000 to 500,000, more preferably from 2,000 to 250,000 even more preferably from 5,000 to 200,000.

The setting polymer according to the present invention may be any water-soluble or water dispersible polymer. Preferably the polymer is a film-forming polymer or mixture of such polymers. This includes homopolymers or copolymers of natural or synthetic origin having functionality rendering the polymers water-soluble such as hydroxyl, amine, amide or carboxyl groups. The setting polymers may be cationic, anionic, non-ionic or amphoteric.

The polymers make be a single species of polymer or a mixture thereof. Preferably the setting polymer is selected from: anionic polymers, non-ionic polymers, amphoteric polymers and mixtures thereof. For all polymers herein described it is intended to cover both the acids and salts thereof.

Suitable cationic setting polymers are preferably selected from the group consisting of: quaternized acrylates or methacrylates; quaternary homopolymers or copolymers of vinylimidazole; homopolymers or copolymers comprising a quaternary dimethdiallyl ammonium chloride; cationic polysaccharides; cationic cellulose derivatives; chitosans and derivatives thereof; and mixtures thereof. For example, hydroxyethylcellulose dimethyldiallyammonium chloride [PQ4] sold as Celquat L200 ex. Akzo Nobel, Quaternized hydroxyethylcellulose [PQ10] sold as UCARE JR125 ex Dow Personal Care, Hydagen HCMF ex. Cognis and N-Hance 3269 ex Ashland.

Suitable anionic setting polymers may be selected from polymers comprising groups derived from carboxylic or sulfonic acids. Copolymers containing acid units are generally used in their partially or totally neutralized form, more preferably totally neutralized. Suitable anionic setting polymer may comprise: (a) at least one monomer derived from a carboxylic acid or sulfonic acid such or their salts and (b) one or more monomers selected from the group consisting of: esters of acrylic acid and/or methacrylic acid, acrylate esters grafted onto a polyalkylene glycol, hydroxyesters acrylate, acrylamides, methacrylamides which may or may not be substituted on the nitrogen by lower alkyl groups, hydroxyalkylated acrylamide, amino alkylated, alkylacrylamine, alkylether acrylate, monoethylenic monomer, styrene, vinyl esters, allyl esters or methallyl esters, vinyllactams, alkyl maleimide, hydroxyalkyl maleimide, and mixtures thereof. When present the anhydride functions of these polymers can optionally be monoesterified or monoamidated. Alternatively, the anionic setting polymer may be selected from a water-soluble polyurethane, anionic polysaccharides and combinations thereof. Preferred anionic setting polymers may be selected from: copolymers derived from acrylic acid such as the acrylic acid.

Non-ionic setting polymers may be natural, synthetic or mixtures thereof. Synthetic non-ionic setting polymers are selected from: homopolymers and copolymers comprising: (a) at least one of the following main monomers: vinylpyrrolidone; vinyl esters grafted onto a polyalkylene glycol; acrylate esters grafted onto a polyalkylene glycol or acrylamide and (b) one or more other monomers such as vinyl esters, alkylacrylamine, vinylcaprolactam, hydroxyalkylated acrylamide, amino alkylated acrylamide, vinyl ether; alkyl maleimide, hydroxyalkyl maleimide, and mixtures thereof. Suitable natural non-ionic setting polymers are water-soluble. Preferred natural non-ionic polymers are selected from: non-ionic polysaccharides including: non-ionic cellulose, non-ionic starches, non-ionic glycogens, non-ionic chitins and non-ionic guar gums; cellulose derivative, such as hydroxyalkylcelluloses and mixtures thereof. The non-ionic setting polymers are preferably selected from vinylpyrrolidone/vinyl acetate copolymers and such as vinylpyrrolidone homopolymer.

Amphoteric setting polymers may be natural, synthetic or a mixture thereof. Suitable synthetic amphoteric setting polymers include those comprising: an acid and a base like monomer; a carboxybetaine or sulfobetaine zwitterionic monomer; and an alkylamine oxide acrylate monomer. An example of such an amphoteric setting polymer is acrylates/ethylamine oxide methacrylate sold as Diaformer Z 731 N by Clariant; and mixtures thereof.

Preferably the setting polymer is selected from acrylate polymers, co-polymers comprising acrylate monomers, starches, celluloses, derivatives of cellulose and mixtures thereof. Most preferably the setting polymer is selected from the group consisting of: acrylates and copolymers of two or more acrylate monomers such as: (meth)acrylic acid or one of their simple esters; octylacrylamide/acrylate/butylaminoethyl methacrylate copolymers; acrylates/hydroxyesters acrylates copolymers of butyl acrylate, methyl methacrylate, methacrylic acid, ethyl acrylate and hydroxyethyl methacrylate; polyurethane-14/AMP-acrylates copolymer blend; and mixtures thereof. This includes both the acids and salts thereof.

Other Ingredients

The compositions of the present invention are aqueous fabric sprays. Preferably at least 60 wt. % of the composition is water, more preferably at least 70 wt. %. Preferably the composition comprises less than 99 wt. % water, more preferably less than 98%.

The compositions of the present invention may contain further optional laundry ingredients. Such ingredients include preservatives (including biocides) pH buffering agents, perfume carriers, hydrotropes, polyelectrolytes, anti-shrinking agents, anti-oxidants, anti-corrosion agents, drape imparting agents, anti-static agents, ironing aids, antifoams, colorants, pearlisers and/or opacifiers, natural oils/extracts, processing aids, e.g. electrolytes, hygiene agents, e.g. anti-bacterials, antivirals and antifungals, thickeners and skin benefit agents.

Spray Bottle

The compositions are fabric spray compositions. By this is meant that the compositions are suitable for spraying onto a fabric. They may be sprayed by any suitable spraying device.

Preferably the spray device is a manually operable spray device in the sense that the spray mechanism is manually operable to discharge a dose of said composition from the nozzle. The spray mechanism may be operated by an actuator. The actuator can be a push actuator or a pull actuator. The actuator may comprise a trigger. The spray mechanism may comprise a hand-operable pump. Optionally, said pump is one of: a positive displacement pump; a self-priming pump; a reciprocating pump. Suitable spray devices include trigger sprays, continuous/semi-continuous sprays, finger pump sprays, vibrating mesh device output sprays.

Preferably the spray device is operable without the use of a propellant. Indeed, propellant-free spray devices are preferred. This allows the spray to maintain the integrity and purity of the product, uncontaminated with propellant and is preferably environmentally.

Preferably the spray device is pressurised. This can improve spray duration and velocity. Preferably the spray device is pressurised by a gas chamber, separate from the reservoir containing the composition. The gas is preferably air or nitrogen. The spray device may comprise an outer container containing the composition and a pressurizing agent, wherein the composition is segregated from the pressurizing agent by containment (preferably hermetically sealed) in a flexible pouch. This which maintains complete formulation integrity so that only pure (i.e. excludes pressurising agent) composition is dispensed. Preferred systems are the so-called ‘bag-in-can’ (or BOV, bag-on-valve technology). Alternatively, the spray device may comprise piston barrier mechanism, for example EarthSafe by Crown Holdings.

Preferably the spray device comprises a biodegradable plastic material. Preferably the spray device comprises recycled plastic, in particular PCR. “post-consumer resin (PCR)” typically means plastic that has been collected via established consumer recycling streams, sorted, washed and reprocessed, for example into pellets.

The spray mechanism may further comprise an atomiser configured to break up said liquid dose into droplets and thereby facilitate creation of said fine aerosol in the form of a mist. Conveniently, said atomiser may comprise at least one of: a swirl chamber and a lateral dispersion chamber. Suitably, the atomiser functions to mix air with the aqueous fabric spray composition.

The particle size of the formulation when sprayed is preferably no more than 300 μm, preferably no more than 250 μm, preferably no more than 150 μm, preferably no more than 125 μm, preferably no more than 100 μm. The particle size of the formulation when sprayed is preferably at least 5 μm, preferably at least 10 μm, preferably at least 15 μm, preferably at least 20 μm, preferably at least 30 μm, preferably at least 40 μm. Suitably the spray comprises droplets having an average diameter in the range of preferably 5 to 300 μm, more preferably 10 to 250 μm, most preferably 15 to 150 μm. This size allows for homogeneous distribution and a balance between sufficient wetting of the fabric, without potential fabric damage caused by excessive dosing of certain ingredients. Droplet size may be measured on a Malvern Spraytec instrument, with the peak maximum corresponding to the average droplet size. The parameter droplet size is the volume mean diameter, D[4,3].

Suitably, following actuation, the spray has a duration in the range of at least 0.4 seconds. Preferably the spray has a duration of at least 0.8 seconds. A longer duration minimises the effort by maximising coverage per actuation of a spray device. This is an important factor for products designed to be used over the full area of garments. Preferably the spray duration is directly linked to actuation such that the spray output continues only as long as the actuator is activated (e.g. as long as a button or trigger is pressed).

Spray reservoirs may be non-pressurised, manually or mechanically pre-pressurised devices. The above also to removable/refillable reservoirs.

According to a further aspect of the present invention, there is provided a replacement reservoir for a garment refresh product according to the above aspect(s), the replacement reservoir being pre-filled with a volume of said spray composition for replenishment of said product. A suitable “refill kit” comprises one or more reservoirs. In the case of more than one reservoir, for example two, three, four, five, or more reservoirs, the contents (aqueous fabric spray composition) of each reservoir may the same as or different from the other reservoirs.

Method of Producing the Fabric Sprays

In one aspect of the present invention is provided a method of preparing a fabric spray composition, wherein the method comprises the steps of:
i. Obtaining an ingredient comprising at least one ethoxylate unit and at least one carbon derived from carbon capture;
ii. Incorporating said ingredient into a fabric spray composition.

Preferably the fabric spray composition is then packaged in a spray device as described herein.

Use of the Fabric Sprays

In one aspect of the present invention is provided a use of a fabric spray as described herein to reduce carbon emissions into the atmosphere. This is achieved by re-using carbon which is already in the atmosphere or which will be emitted into the atmosphere (e.g. from industry) rather than using carbon from virgin fossil fuels. The fabric sprays as described herein can contribute to slowing the rate of carbon entering the atmosphere. In other words carbon derived from carbon capture can be used in a fabric spray to reduce carbon emissions in the atmosphere. This is achieved by re-using carbon which has been or will be emitted into the atmosphere rather than using virgin petrochemicals.

Additionally, the use of an ingredient comprising at least one ethoxylate unit and at least one carbon derived from carbon capture provides the consumer with a tangible eco marker in the product. Accordingly, in one aspect of the present invention is provided a use of an ingredient comprising at least one ethoxylate unit and at least one carbon derived from carbon capture as a tangible eco marker in a fabric spray composition. The tangible eco marks the change in carbon providence for the consumer. This may be a change in the smell of the product. In other words carbon derived from carbon capture may be used to change the fragrance of a fabric spay, thereby providing the consumer with a tangible marker and a reason to believe.

Conveniently, the spray composition is provided as a liquid, and said spray mechanism is operable to discharge a dose of at least 0.1 ml, preferably at least 0.2 ml, more preferably at least 0.25 ml, more preferably at least 0.3 ml, more preferably at least 0.35 ml, more preferably at least 0.35 ml, more preferably at least 0.4 ml, more preferably at least 0.45 ml, and most preferably at least 0.5 ml.

Suitably the dose is no more than 2 ml, preferably no more than 1.8 ml, preferably no more than 1.6 ml, more preferably no more than 1.5 ml, more preferably no more than 1.4 ml, more preferably no more than 1.3 ml, and most preferably no more than 1.2 ml.

Suitably the dose is between 0.1 and 2 ml of said liquid spray composition, preferably between 0.2 and 1.8 ml, more preferably 0.25 to 1.6 ml, more preferably 0.25 to 1.5 ml, and most preferably 0.25 to 1.2 ml.

These doses have been found to be particularly effective at achieving the desired garment refresh effect without unsightly and wasteful large droplet formation.

The dose may alternatively be defined as ml per m² of fabric. Preferably the spray composition of the present invention is dosed as 0.1 to 20 ml per m². More preferably 0.5 to 15 ml per m² and most preferably 1 to 10 ml per m².

### Examples

The following ingredients are illustrative of ingredient comprising at least one ethoxylate unit and at least one carbon derived from carbon capture.

TABLE 1
Alcohol ethoxylate

| | Ethoxylate (25EO) | Alkyl (C16/18) |
|---|---|---|
| Comparative A | Virgin fossil fuel | Virgin fossil fuel |
| Example 1 | Virgin fossil fuel | Carbon Capture |
| Example 2 | Carbon Capture | Palm oil |
| Example 3 | Carbon Capture | Carbon Capture |

TABLE 2
Polyethylene glycol (molecular weight 200)

| | Ethylene oxide |
|---|---|
| Comparative B | 100% Virgin fossil fuel |
| Example 4 | 30% Virgin fossil fuel, 70% carbon capture |
| Example 5 | 50% bioethanol, 50% carbon capture |
| Example 6 | 100% Carbon Capture |

The following compositions are fabric spray compositions according to the present invention:

TABLE 3
Fabric Spray

wt. % active

| | Example 7 | Example 8 |
|---|---|---|
| Alcohol ethoxylate - Example 3 | — | 0.5 |
| PEG - Example 4 | 1.5 | — |
| Free perfume | 2 | 1 |
| Malodour counteractant | — | 0.02 |
| Amino silicone emulsion¹ | — | 2 |
| Polyacrylate co-polymer | — | 0.2 |
| Water | To 100 | To 100 |

Amino silicone emulsion¹—FC222 ex. Wacker Chemie

Product Assessment:

TABLE 4
Compositions

wt. % inclusion

| Ingredient | A | 1 |
|---|---|---|
| Nonionic surfactant¹ | 1.2 | — |
| Nonionic surfactant² | — | 1.2 |
| Xanthan gum | 2 | 2 |
| Fragrance oil | 3 | 3 |
| Perfume microcapsule | 3 | 3 |
| Minors | <1 | <1 |
| Water | To 100 | To 100 |

Nonionic surfactant¹—Cetostryl Alcohol ethoxylate with 25EO (EO groups derived from petrochemicals)
Nonionic surfactant²—Cetostryl Alcohol ethoxylate with 25EO (EO groups derived from carbon capture)

The compositions were prepared by the following method. The xanthan gum was dispersed in cold water. The dispersed xanthan was then mixed with water at a temperature of ˜60° C. The nonionic surfactant was heated to ˜65° C. and the fragrance oil mixed in. This premix was added to the water and xanthan mix. The perfume microcapsules were finally added with stirring.

A fragrance assessment was carried out on both compositions. Both compositions comprised the same amount of the same perfume, however it was identified composition 1 smelt ‘fresher’.

The inclusion of a non-ionic surfactant comprising at least one ethoxylate unit and at least one carbon derived from carbon capture led to a different product smell, which marks a difference between the products for the consumers.

1-14. (canceled)

15. A fabric spray composition comprising:
an ingredient comprising at least one ethoxylate unit and at least one carbon derived from carbon capture, and wherein at least 50 wt. % of the carbon in the ingredient are obtained from carbon capture.

16. The fabric spray according to claim 15, wherein the fabric spray composition further comprises a perfume.

17. The fabric spray according to claim 15, wherein the fabric spray comprises at least 60 wt. % water.

18. The fabric spray according to claim 15 wherein the composition comprises from 0.1 to 5 wt. % of the ingredient comprising at least one ethoxylate unit and at least one carbon derived from carbon capture.

19. The fabric spray according to claim 15, wherein less than 90 wt. %, of the carbon in the ingredient comprising at least one ethoxylate unit and at least one carbon derived from carbon capture is obtained directly from virgin fossil fuel sources.

20. The fabric spray according to claim 15, wherein the carbon derived from carbon capture forms part of an alkyl chain or an ethoxylate group.

21. The fabric spray according to claim 15, wherein the ingredient is selected from the group consisting of alcohol ethoxylates, polyethylene glycols and materials substituted with polyethylene glycols.

22. The fabric spray according to claim 15, wherein all carbons within the ingredient are derived from carbon capture or a combination of carbon capture and plant source.

23. The fabric spray according to claim 15, wherein the carbon obtained from carbon capture is obtain from point source carbon capture.

24. A method of preparing the fabric spray composition according to claim 15, wherein the method comprises the steps of:
i. obtaining an ingredient comprising at least one ethoxylate unit and at least one carbon derived from carbon capture;
ii incorporating said ingredient into a composition; and
iii. recovering the fabric spray composition.

25. The method of preparing the fabric spray composition according to claim 24, wherein the method further comprises the step of adding preservative, pH buffering agent, perfume carrier, hydrotrope, polyelectrolyte, anti-shrinking agent, anti-oxidant, anti-corrosion agent, drape imparting agent, anti-static agent, ironing aid, antifoam, colorants, pearliser, opacifier, electrolyte, anti-bacterial, antiviral, antifungal, thickener, skin benefit agent or a mixture thereof.

26. The method of preparing the fabric spray composition according to claim 24, wherein the method further comprises the step of adding a fabric softening silicone.

27. The method of preparing the fabric spray composition according to claim 24, wherein the method further comprises the step of adding activated carbon.
